(19) United States
(12) Patent Application Publication
(10) Pub. No.: US 2026/0014797 A1
(43) Pub. Date: Jan. 15, 2026

(54) Consumable Cartridge

(71) Applicant: Zhuhai Ninestar Management Co., Ltd., Zhuhai (CN)

(72) Inventor: Weijian CHEN, Zhuhai (CN)

(21) Appl. No.: 19/335,585

(22) Filed: Sep. 22, 2025

Related U.S. Application Data
(63) Continuation of application No. PCT/CN2024/114260, filed on Aug. 23, 2024.

(30) Foreign Application Priority Data
Mar. 28, 2024 (CN) 202420636286.1

(51) Int. Cl. B41J 2/175

(52) U.S. Cl. CPC B41J 2/17513; B41J 2/17553

(57) ABSTRACT

The embodiment of the present application provides a consumable cartridge, which relates to the field of printing technology. The consumable cartridge includes a main body and a face cover; the main body includes a partition, an ink storage chamber and a supplementary chamber; a plurality of communicating parts are arranged on the side of the face cover facing the partition. By arranging a plurality of communicating parts on the side of the face cover facing the partition, the number of times the printer inflates the consumable cartridge during the positive pressure detection process is within the specified threshold range, ensuring that a sufficient amount of ink is supplied to the ink detection chamber. This avoids the situation where the ink detection chamber fails to detect the specified amount of ink, leading to a false prompt that the ink in the consumable cartridge is exhausted, or the printer reports an error.

This application is a continuation application of PCT application No. PCT/CN2024/114260, filed on August 23, 2024, which claims priority to the Chinese patent application filed with the China Patent Office on March 28, 2024, with the application number 202420636286.1 and the title "Consumable Cartridge", the entire contents of which are incorporated into this application by reference.

### FIELD OF THE INVENTION

This application relates to the field of printing technology, and in particular, to a consumable cartridge.

### BACKGROUND OF THE INVENTION

Printers, as common office equipment, provide convenience for modern office work. They include laser printers and inkjet printers. Different models of ink cartridges are compatible with different models of printers. The consumable cartridge is the implementer of the printer's output function, which performs printing tasks by passively receiving instructions. As a tool for containing colors, the consumable cartridge is completely discarded after the ink is consumed, which causes a great waste of consumable resources. Usually, the discarded consumable cartridges are recycled and reused to improve their utilization rate and save energy.

In the existing technology, by processing an unused chamber in the discarded consumable cartridge to connect it with the ink storage chamber, more ink can be filled. Specifically, the face cover corresponding to the upper side of the chamber is cut to fully expose the chamber, and then a communication hole is carved on the partition between the chamber and the ink storage chamber. After the consumable cartridge is refilled with ink, the chamber is filled with ink, and the chamber continuously supplements ink into the ink storage chamber through the communication hole, and then the chamber is covered with a cover plate.

During the use of the recycled consumable cartridge, the printer needs to perform a positive pressure test before executing a printing command. Specifically, the inflation unit in the printer inflates the deformable component arranged in the ink storage chamber through the inflation hole of the consumable cartridge, causing the deformable component to expand and deform, pushing the shrapnel and ball valve on the upper side of the deformable component to close the air guide hole. The ink in the ink storage chamber is supplied to the ink detection chamber of the printer for detection.

However, during the positive pressure test, due to the increase in the internal pressure of the consumable cartridge, the ink stored in the ink storage chamber is squeezed into the chamber. Limited by the structure of the communication hole between the chamber and the ink storage chamber, it is difficult for the ink squeezed into the chamber to flow back into the ink storage chamber. This leads to a reduction in the amount of ink in the ink storage chamber, which in turn reduces the amount of ink supplied to the ink detection chamber of the printer. As a result, the number of times the printer inflates the consumable cartridge increases. Once the number of inflations exceeds the rated threshold, the printer will report an error. Or, because the ink detection chamber does not detect the specified amount of ink, the printer may falsely prompt that the ink is exhausted when there is still ink in the consumable cartridge. This brings inconvenience to users, causes a certain degree of waste, and increases the user's use cost.

In addition, due to reasons such as poor sealing between the cover plate on the upper side of the chamber and the face cover of the consumable cartridge, ink may overflow from the gap between the face cover and the cover plate to the outside of the consumable cartridge during the positive pressure test, causing environmental pollution.

### SUMMARY OF THE INVENTION

The embodiments of the present application provide a consumable cartridge to solve the problems that during the positive pressure detection process, due to the increase in internal pressure of the consumable cartridge, the ink stored in the ink storage chamber is squeezed into the chamber, resulting in a reduction in the amount of ink supplied to the ink detection chamber of the printer, which in turn increases the number of times the printer inflates the consumable cartridge. Once the number of inflations exceeds the rated threshold, the printer will report an error. Or, because the ink detection chamber does not detect the specified amount of ink, the printer may falsely prompt that the ink is exhausted when there is still ink in the consumable cartridge, which brings inconvenience to users, causes a certain degree of waste, and increases the user's use cost. It also solves the problem that during the positive pressure detection process, ink may overflow from the gap between the face cover and the cover plate to the outside of the consumable cartridge, causing pollution.

The embodiments of the present application provide a consumable cartridge, which includes a main body and a face cover.

The main body includes a partition, an ink storage chamber, and a supplementary chamber, and the partition is used to separate the ink storage chamber from the supplementary chamber.

A plurality of communicating parts are arranged on the side of the face cover facing the partition, the plurality of communicating parts are arranged at intervals, the plurality of communicating parts are configured to communicate the ink storage chamber with the supplementary chamber, and each communicating part is closed by the face cover on the side away from the partition.

In a possible implementation, the main body includes a plurality of supplementary chambers, the plurality of supplementary chambers are arranged around the ink storage chamber, and the partition is also used to separate two adjacent supplementary chambers.

The plurality of communicating parts are configured to communicate the ink storage chamber with the plurality of supplementary chambers, and communicate adjacent supplementary chambers.

In a possible implementation, at least one communicating part is provided between each supplementary chamber and the ink storage chamber, and at least one communicating part is provided between two adjacent supplementary chambers.

In a possible implementation, each communicating part is higher than the partition in the height direction of the consumable cartridge, and there is a fluid path between the communicating part and the partition.

In a possible implementation, in the thickness direction of the partition, the communicating part extends from one side of the partition to the other side of the partition.

In a possible implementation, the communicating part is configured to form a depression on the side facing the partition towards the direction away from the partition.

In a possible implementation, the main body includes a first supplementary chamber and a second supplementary chamber, the first supplementary chamber is located on one side of the ink storage chamber in the length direction of the consumable cartridge, and the second supplementary chamber is located on one side of the ink storage chamber in the width direction of the consumable cartridge.

In a possible implementation, the communicating part is correspondingly provided between the first supplementary chamber and the ink storage chamber, the communicating part is correspondingly provided between the second supplementary chamber and the ink storage chamber, and the communicating part is correspondingly provided between the first supplementary chamber and the second supplementary chamber.

In a possible implementation, the volume of the first supplementary chamber is larger than that of the second supplementary chamber.

In a possible implementation, the main body is from an original ink cartridge, a recycled ink cartridge, or a remanufactured ink cartridge.

The embodiments of the present application provide a consumable cartridge, which includes a main body and a face cover; the main body includes a partition, an ink storage chamber, and a supplementary chamber, and the partition is used to separate the ink storage chamber from the supplementary chamber; a plurality of communicating parts are arranged on the side of the face cover facing the partition, the plurality of communicating parts are arranged at intervals, and the plurality of communicating parts are configured to communicate the ink storage chamber with the supplementary chamber, and each communicating part is closed by the face cover on the side away from the partition. By arranging a plurality of communicating parts on the side of the face cover facing the partition, and the plurality of communicating parts communicating the ink storage chamber with the supplementary chamber, when the printer performs positive pressure detection, after the ink in the ink storage chamber is squeezed into the supplementary chamber, the ink in the supplementary chamber can be filled into the ink storage chamber through at least one communicating part, so that the amount of ink in the ink storage chamber is increased, thereby ensuring that a sufficient amount of ink is supplied to the ink detection chamber of the printer through the ink outlet. This ensures that the number of times the printer inflates the consumable cartridge during the positive pressure detection process is within the specified threshold range, avoiding the situation in the prior art where the ink detection chamber does not detect the specified amount of ink during the positive pressure detection process, leading to a false prompt that the ink in the consumable cartridge is exhausted, or the printer reports an error because the number of inflations to the consumable cartridge exceeds the threshold. It ensures the normal use of the consumable cartridge, brings convenience to users, avoids waste, and reduces the user's use cost.

In addition, by replacing the old face cover of the discarded consumable cartridge with a new one, or re-modifying the old face cover and then refilling the consumable cartridge with ink, no ink will overflow during the positive pressure detection process, and no environmental pollution will be caused.

### BRIEF DESCRIPTION OF DRAWINGS

To better illustrate the technical solutions in the embodiments of the present application or the prior art, a brief introduction to the accompanying drawings required for describing the embodiments or the prior art will be given below. Obviously, the accompanying drawings in the following description are some embodiments of the present application. For those of ordinary skill in the art, other drawings can also be obtained based on these drawings without exerting creative labor.

FIG. 1 is a first perspective schematic diagram of a consumable cartridge provided in an embodiment of the present application;

FIG. 2 is a second perspective schematic diagram of the consumable cartridge in FIG. 1;

FIG. 3 is a schematic diagram of the consumable cartridge in FIG. 1 with the face cover removed;

FIG. 4 is an exploded schematic diagram of the consumable cartridge in FIG. 3 with the face cover removed;

FIG. 5 is a structural schematic diagram of the face cover in FIG. 1;

FIG. 6 is a schematic diagram of ink flow during the positive pressure detection process of the consumable cartridge in FIG. 1.

Explanation of reference signs:

10 - main body; 101 - ink storage chamber; 102 - front wall; 103 - inflation port; 104a - ink outlet; 104b - accommodating part; 105a - first supplementary chamber; 105b - second supplementary chamber; 106a - first partition; 106b - second partition; 106c - third partition; 11 - base; 111 - air guide hole; 12 - sealing gasket; 13 - valve component; 14 - third deformation member; 15 - ball valve; 20 - face cover; 201 - inner surface; 21 - guide part; 22 - enclosure part; 23 - installation part; 24a - first communicating part; 24b - second communicating part; 24c - third communicating part; 24d - fourth communicating part; 30 - deformable component; 31 - first deformation member; 32 - second deformation member; 321 - installed part; 40 - chip.

### DETAILED DESCRIPTION OF THE INVENTION

To make the objectives, technical solutions, and advantages of the embodiments of the present application clearer, the technical solutions in the embodiments of the present application will be clearly and completely described below in conjunction with the accompanying drawings in the embodiments of the present application. Obviously, the described embodiments are part of the embodiments of the present application, rather than all the embodiments. Based on the embodiments in the present application, all other embodiments obtained by those of ordinary skill in the art without creative work shall fall within the protection scope of the present application.

It should be noted that the terms "first" and "second" are only used for descriptive purposes, and cannot be understood as indicating or implying relative importance or implicitly indicating the quantity of indicated technical features. Therefore, the features defined with "first" and "second" may explicitly or implicitly include at least one such feature. In the description of the present application, the meaning of "plurality" is at least two, such as two, three, etc., unless otherwise clearly and specifically defined.

In the present application, unless otherwise clearly specified and limited, the terms "installation", "connection", "fixation" and other terms should be understood in a broad sense. For example, it can be a fixed connection, a detachable connection, or an integral connection; it can be a mechanical connection, an electrical connection, or a communication with each other; it can be a direct connection, or an indirect connection through an intermediate medium, or an internal communication between two elements or an interaction relationship between two elements, unless otherwise clearly defined. For those of ordinary skill in the art, the specific meanings of the above terms in the present application can be understood according to specific situations.

In the present application, unless otherwise clearly specified and limited, a first feature being "on" or "under" a second feature may mean that the first and second features are in direct contact, or that the first and second features are in indirect contact through an intermediate medium. Moreover, a first feature being "above", "over" and "on" a second feature may mean that the first feature is directly above or obliquely above the second feature, or simply means that the horizontal height of the first feature is higher than that of the second feature. A first feature being "below", "under" and "beneath" a second feature may mean that the first feature is directly below or obliquely below the second feature, or simply means that the horizontal height of the first feature is lower than that of the second feature.

In the above description, references to the terms "one embodiment", "some embodiments", "examples", "specific examples", or "some examples" etc., mean that a specific feature, structure, material, or characteristic described in conjunction with the embodiment or example is included in at least one embodiment or example of the present application. In this specification, the schematic representations of the above terms do not necessarily refer to the same embodiment or example. Furthermore, the specific features, structures, materials, or characteristics described can be combined in any one or more embodiments or examples in a suitable manner. In addition, those skilled in the art can combine and combine different embodiments or examples and features of different embodiments or examples described in this specification without conflicting with each other. As mentioned in the background, during the positive pressure detection process, due to the increase in the internal pressure of the consumable cartridge, the ink stored in the ink storage chamber is squeezed into the chamber, resulting in a reduction in the amount of ink supplied to the ink detection chamber of the printer and an increase in the number of times the printer inflates the consumable cartridge. Once the number of inflations exceeds the threshold, the printer will report an error. Or, because the ink detection chamber does not detect the specified amount of ink, the printer may falsely prompt that the ink is exhausted when there is still ink in the consumable cartridge, which brings inconvenience to users, causes a certain degree of waste, and increases the user's use cost. The inventor's research found that the reason for this problem is that in the prior art, a communication hole is carved in the partition between the chamber and the ink storage chamber. Due to the limitations of the size and structure of the communication hole, during the positive pressure detection process, the ink stored in the ink storage chamber is squeezed into the chamber, and the ink in the chamber cannot flow back to the ink storage chamber, resulting in a reduction in the amount of ink supplied to the ink detection chamber of the printer and an increase in the number of times the printer inflates the consumable cartridge. Once the number of inflations exceeds the rated threshold, the printer will report an error. Or, because the ink detection chamber does not detect the specified amount of ink, the printer may falsely prompt that the ink is exhausted when there is still ink in the consumable cartridge, which brings inconvenience to users, causes a certain degree of waste, and increases the user's use cost.

In addition, due to reasons such as poor sealing between the cover plate on the upper side of the chamber and the face cover of the consumable cartridge, ink may overflow from the gap between the face cover and the cover plate to the outside of the consumable cartridge during the positive pressure detection process, causing environmental pollution. In order to solve the above problems, the embodiments of the present application provide a consumable cartridge with a new face cover. A plurality of communicating parts are arranged on the side of the face cover facing the partition, and the plurality of communicating parts communicate the ink storage chamber with the supplementary chamber. When the printer performs positive pressure detection, after the ink in the ink storage chamber is squeezed into the supplementary chamber, the ink in the supplementary chamber can be filled into the ink storage chamber through at least one communicating part, so that the amount of ink in the ink storage chamber is increased, thereby ensuring that a sufficient amount of ink is supplied to the ink detection chamber of the printer through the ink outlet. This ensures that the number of times the printer inflates the consumable cartridge during the positive pressure detection process is within the specified threshold range, avoiding the situation in the prior art where the ink detection chamber does not detect the specified amount of ink during the positive pressure detection process, leading to a false prompt that the ink in the consumable cartridge is exhausted, or the printer reports an error because the number of inflations to the consumable cartridge exceeds the threshold. It ensures the normal use of the consumable cartridge, brings convenience to users, avoids waste, and reduces the user's use cost. In addition, after removing the old face cover of the discarded consumable cartridge, refilling it with ink, and installing a new face cover, no ink will overflow during the positive pressure detection process, and no environmental pollution will be caused.

The consumable cartridge provided by the embodiments of the present application will be described in detail below in conjunction with specific embodiments.

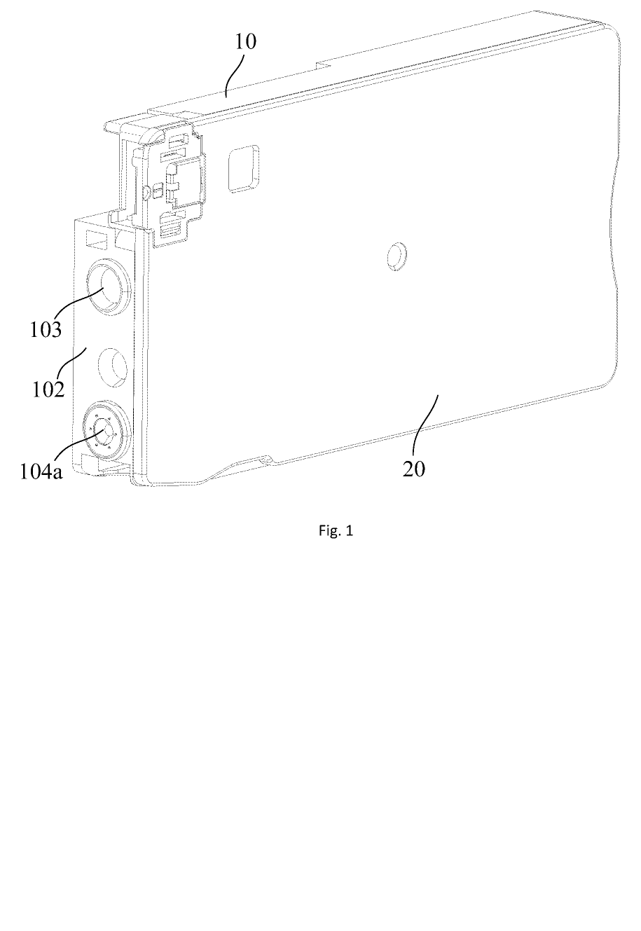

As shown in FIGS. 1 to 6, the embodiment of the present application provides a consumable cartridge, which includes a main body 10 and a face cover 20; the main body includes a partition, an ink storage chamber 101, and a supplementary chamber, and the partition is used to separate the ink storage chamber 101 from the supplementary chamber; a plurality of communicating parts are arranged on the side of the face cover 20 facing the partition, the plurality of communicating parts are arranged at intervals, and the plurality of communicating parts are configured to communicate the ink storage chamber 101 with the supplementary chamber, so that when the printer performs positive pressure detection, after the ink in the ink storage chamber 101 is squeezed into the supplementary chamber, the ink in the supplementary chamber is filled into the ink storage chamber 101 through at least one communicating part.

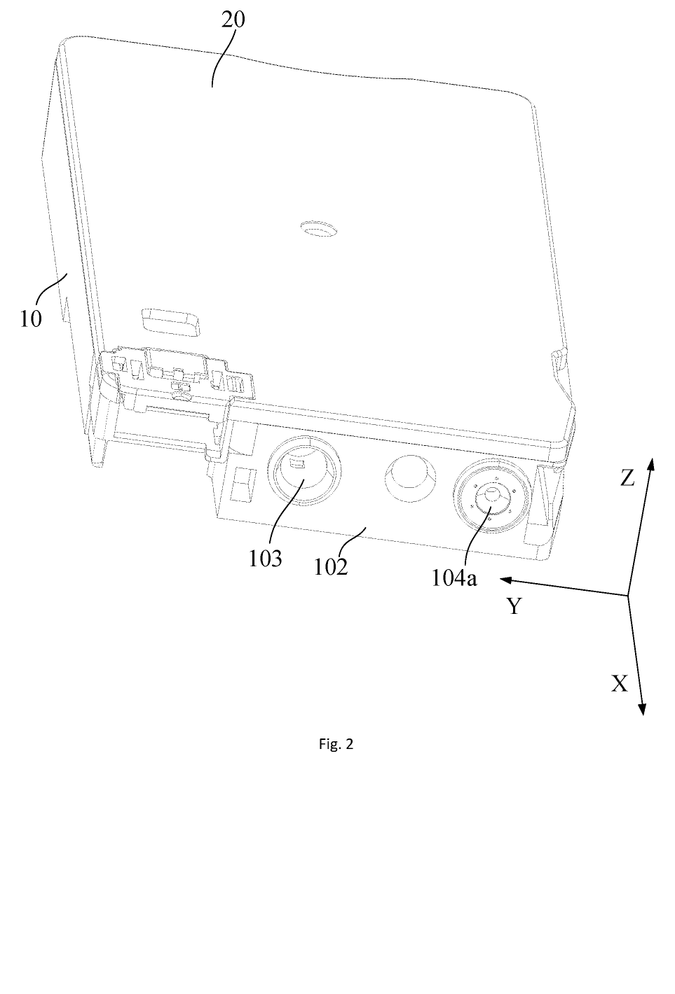

Among them, as shown in FIG. 2, the length direction of the consumable cartridge is the X-axis direction, the width direction of the consumable cartridge is the Y- axis direction, and the height direction of the consumable cartridge is the Z-axis direction, where the X-axis, Y-axis, and Z-axis are perpendicular to each other.

The main body is from an original ink cartridge, a recycled ink cartridge, or a remanufactured ink cartridge.

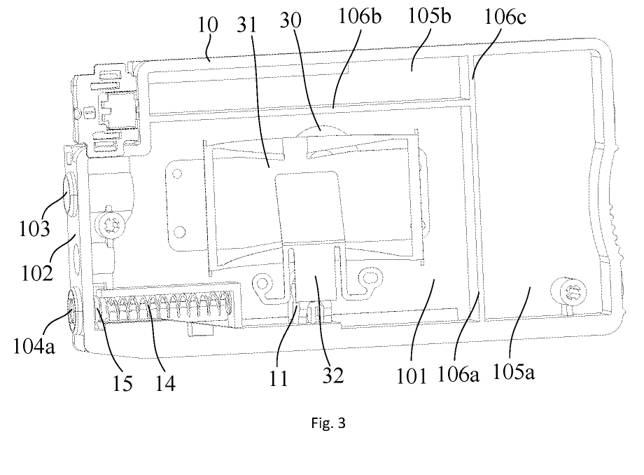

As shown in FIG. 3, the consumable cartridge includes a pressure control component, which includes a deformable component 30 (i.e., a transparent bag-like structure) and a first deformation member 31. The deformable component 30 and the first deformation member 31 are arranged in the ink storage chamber 101, and the first deformation member 31 is located on the upper side of the deformable component 30. Specifically, in the height direction of the consumable cartridge, the first deformation member 31 is located on the upper side of the deformable component 30, and compared with the first deformation member 31, the deformable component 30 is located on the side away from the face cover 20, and at the same time, the first deformation member 31 is in contact with the face cover 20.

The material of the first deformation member 31 can be metal. The first deformation member 31 can deform when subjected to an external force, and after the external force is removed, the first deformation member 31 returns to its initial state under its own elastic force. The initial state of the first deformation member 31 is the state in which the first deformation member 31 is not subjected to an external force.

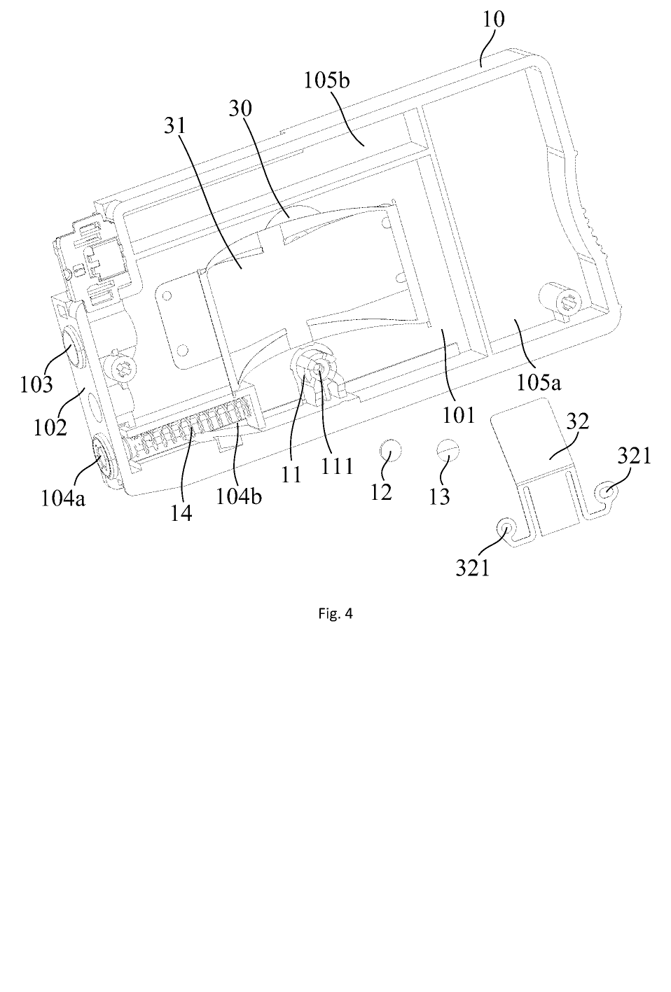

As shown in FIG. 4, the air control component includes a second deformation member 32 and a valve component 13. The ink storage chamber 101 is provided with a base 11, and the base 11 has an air guide hole 111 for communicating the consumable cartridge with the external atmosphere. The valve component 13 is located in the base 11, and the base 11 is also provided with a sealing gasket 12. Compared with the valve component 13, the sealing gasket 12 is closer to the air guide hole 111, that is, in the height direction of the consumable cartridge, the sealing gasket 12 is located between the base 11 and the valve component 13.

In the height direction of the consumable cartridge, the second deformation member 32 is respectively located on the upper side of the first deformation member 31 and the valve component 13, and a part of the second deformation member 32 is in contact with the first deformation member 31, and another part of the second deformation member 32 is in contact with the valve component 13.

The material of the second deformation member 32 can be metal. The second deformation member 32 can deform when subjected to an external force, and after the external force is removed, the second deformation member 32 returns to its initial state under its own elastic force. The initial state of the second deformation member 32 is the state in which the second deformation member 32 is not subjected to an external force.

In the length direction of the consumable cartridge, the main body 10 has a front wall 102, which is located on the side of the main body 10 in the +X-axis direction. The front wall 102 is provided with an inflation port 103 and an ink outlet part. One end of the deformable component 30 is connected to the inflation port 103, that is, the deformable component 30 is only connected to the inflation port 103 and not to the ink storage chamber 101. When inflating through the inflation port 103, gas can enter the deformable component 30, causing the deformable component 30 to expand and deform. When exhausting through the deformable component 30, the gas in the deformable component 30 is exhausted through the inflation port 103. The ink outlet part is connected to the ink storage chamber 101.

As shown in FIGS. 3 and 4, the ink outlet part includes an opening and closing component and an ink outlet 104a. The ink outlet 104a is arranged on the front wall 102 of the consumable cartridge. The ink storage chamber 101 is provided with an accommodating part 104b for accommodating the opening and closing component. The opening and closing component includes a third deformation member 14, a ball valve 15, and a sealing plug (not shown in the figure). The ball valve 15 is located between the third deformation member 14 and the sealing plug, one end of the ball valve 15 is connected to the sealing plug, and the sealing plug is installed in the ink outlet 104a.

When the consumable cartridge is loaded into the printer, the inflation unit in the printer is connected to the inflation port 103, and the ink supply unit is connected to the ink storage chamber 101 through the ink outlet 104a.

The material of the third deformation member 14 can be metal. The third deformation member 14 can deform when subjected to an external force, and after the external force is removed, the third deformation member 14 returns to its initial state under its own elastic force. The initial state of the third deformation member 14 is the state in which the third deformation member 14 is not subjected to an external force.

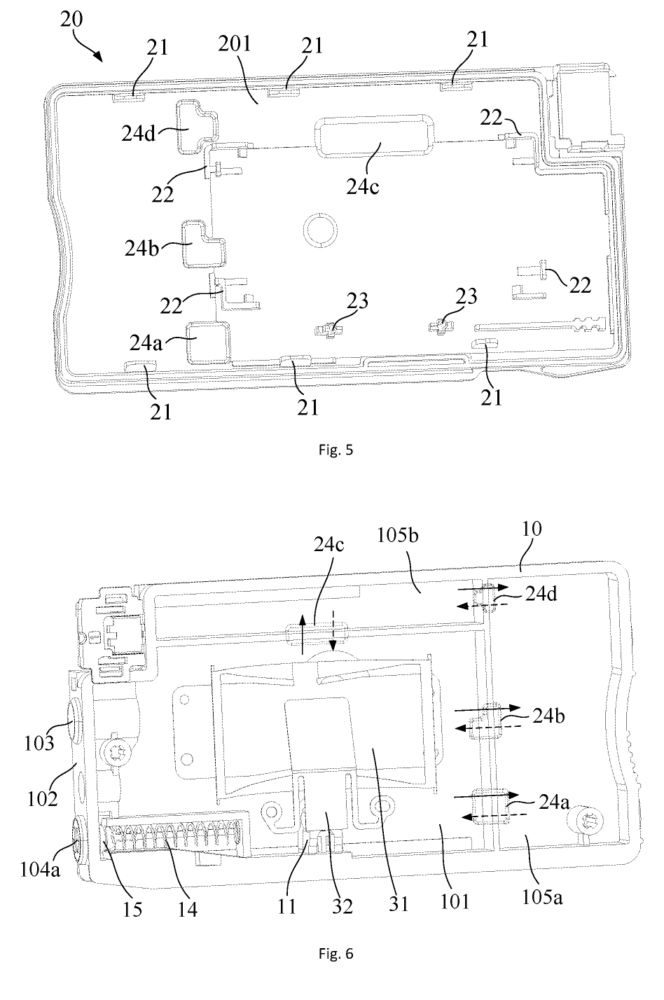

As shown in FIG. 5, the side of the face cover 20 facing the ink storage chamber 101 has an inner surface 201, and the inner surface 201 is provided with a plurality of guide parts 21, which are located around the inside of the face cover 20 and used to guide the installation of the face cover 20 and the main body 10 during the installation process of the main body 10 and the face cover 20. The guide part 21 can be a guide plate. When the face cover 20 is installed with the main body 10, a plurality of guide plates are in contact with the inner wall of the main body 10, which can guide the installation of the face cover 20 and the main body 10.

The inner surface 201 is also provided with a plurality of enclosure parts 22, and an accommodating space is formed between the enclosure parts 22. When the face cover 20 and the main body 10 are in the installed state, the first deformation member 31 is located in the accommodating space, and the enclosure parts 22 are used to limit the position of the first deformation member 31. In this embodiment, the first deformation member 31 abuts against the main body 10 and the face cover 20 respectively, and the enclosure parts 22 can be enclosure blocks. When the face cover 20 is installed with the main body 10, a plurality of enclosure blocks are arranged on the edge of the first deformation member 31, which can limit the position of the first deformation member 31 in the plane defined by the X-axis and Y-axis, preventing the first deformation member 31 from moving in the plane defined by the X-axis and Y-axis.

As shown in FIGS. 4 and 5, a plurality of installation parts 23 are arranged adjacent to the accommodating space. In this embodiment, the number of installation parts 23 is two. The second deformation member 32 has an installed part 321, and the second deformation member 32 is connected to the installation part 23 through the installed part 321 provided thereon, so as to realize the installation of the second deformation member 32 and the face cover 20. Specifically, the installation part 23 can be a rod structure, the installed part 321 is a hole structure, and the installed part 321 can be clamped on the installation part 23.

The consumable cartridge also has a chip 40, which is installed on the main body 10 through a chip holder. The chip 40 can establish a communication connection with the stylus of the printer.

When the consumable cartridge is loaded into the printer, the printer needs to perform a positive pressure detection before executing the printing command, that is, to determine the amount of ink in the consumable cartridge. Specifically: the inflation unit in the printer inflates the consumable cartridge through the inflation port 103 of the consumable cartridge, and the deformable component 30 deforms toward the face cover 20, causing the first deformation member 31 located above it and in contact with the deformable component 30 to also deform toward the face cover 20. Under this external force, the second deformation member 32 located on the upper side of the first deformation member 31 rotates toward the face cover 20 with the valve component 13 as the rotation fulcrum, and at the same time applies a force to the valve component 13 located in the base 11, pushing the valve component 13 and the sealing gasket 12 to move toward the air guide hole 111 together, so that the air guide hole 111 is closed by the sealing gasket 12, and at this time, the internal pressure of the consumable cartridge is greater than the external pressure.

The number of supplementary chambers can be one or more.

When the number of supplementary chambers is one, and the printer performs positive pressure detection, due to the expansion of the deformable component 30 provided in the ink storage chamber 101, part of the ink stored in the ink storage chamber 101 of the consumable cartridge is squeezed into the ink amount detection chamber provided in the printer through the ink outlet part, and the other part is squeezed into the supplementary chamber adjacent to the ink storage chamber 101 through a plurality of communicating parts. When the amount of ink in the supplementary chamber reaches the maximum value, the ink squeezed into the supplementary chamber and the originally stored ink in the supplementary chamber will be refilled into the ink storage chamber 101 through the communicating parts, so that the amount of ink in the ink storage chamber 101 is increased, thereby ensuring that a sufficient amount of ink is supplied to the ink detection chamber of the printer through the ink outlet 104a. This ensures that the number of times the printer inflates the consumable cartridge during the positive pressure detection process is within the specified threshold range, avoiding the situation in the prior art where the ink detection chamber does not detect the specified amount of ink during the positive pressure detection process, leading to a false prompt that the ink in the consumable cartridge is exhausted, or the printer reports an error because the number of inflations to the consumable cartridge exceeds the threshold. It ensures the normal use of the consumable cartridge, brings convenience to users, avoids waste, and reduces the user's use cost.

When there are a plurality of supplementary chambers, the plurality of supplementary chambers are arranged around the ink storage chamber 101, and the partition is also used to separate two adjacent supplementary chambers; the plurality of communicating parts are configured to communicate the ink storage chamber 101 with the plurality of supplementary chambers and to communicate adjacent supplementary chambers. When the printer performs positive pressure detection, part of the ink stored in the ink storage chamber 101 of the consumable cartridge is squeezed into the ink quantity detection chamber provided in the printer through the ink outlet part, and the other part is squeezed into some supplementary chambers adjacent to the ink storage chamber 101 through the plurality of communicating parts. When the amount of ink squeezed into one or more of the supplementary chambers reaches the maximum, the ink squeezed into the one or more supplementary chambers and the originally stored ink in the supplementary chambers will be refilled into the ink storage chamber 101 through the corresponding communicating parts; alternatively, when the printer performs positive pressure detection, part of the ink stored in the ink storage chamber 101 of the consumable cartridge is squeezed into the ink quantity detection chamber provided in the printer through the ink outlet part, and the other part is squeezed into some supplementary chambers adjacent to the ink storage chamber 101 through the plurality of communicating parts. When the amount of ink in one or more supplementary chambers reaches the maximum, the ink squeezed into the one or more supplementary chambers and the originally stored ink in the supplementary chambers are refilled into one or more adjacent supplementary chambers through the corresponding communicating parts. When the amount of ink in the one or more adjacent supplementary chambers reaches the maximum, the ink squeezed into the one or more adjacent supplementary chambers and the originally stored ink in the adjacent supplementary chambers are refilled into the ink storage chamber 101. This arrangement increases the amount of ink in the ink storage chamber 101, thereby ensuring that a sufficient amount of ink is supplied to the ink detection chamber of the printer through the ink outlet 104a. As a result, the number of times the printer inflates the consumable cartridge during the positive pressure detection process is within the specified threshold range, avoiding situations in the prior art where the ink detection chamber fails to detect the specified amount of ink during positive pressure detection, leading to false prompts that the ink in the consumable cartridge is exhausted, or the printer reports an error because the number of inflations to the consumable cartridge exceeds the threshold. This ensures the normal use of the consumable cartridge, brings convenience to users, avoids waste, and reduces the user's usage cost.

Exemplarily, the number of supplementary chambers is two, each supplementary chamber is communicated to the ink storage chamber 101 through at least one communicating part, and the two supplementary chambers are communicated through at least one communicating part. When the printer performs positive pressure detection while executing a printing command, part of the ink stored in the ink storage chamber 101 of the consumable cartridge is squeezed into the ink quantity detection chamber provided in the printer through the ink outlet part, and the other part is squeezed into one supplementary chamber through the corresponding communicating part. When the amount of ink in this supplementary chamber reaches the maximum, the ink squeezed into this supplementary chamber and the originally stored ink in this supplementary chamber will be refilled into the ink storage chamber 101 through the corresponding communicating part; alternatively, when the printer performs positive pressure detection while executing a printing command, part of the ink stored in the ink storage chamber 101 of the consumable cartridge is squeezed into the ink quantity detection chamber provided in the printer through the ink outlet part, and the other part is squeezed into one supplementary chamber through the corresponding communicating part. When the amount of ink in this supplementary chamber reaches the maximum, part of the ink squeezed into this supplementary chamber and the originally stored ink in this supplementary chamber is refilled into the ink storage chamber 101 through the corresponding communicating part, and the other part is squeezed into the adjacent supplementary chamber. When the amount of ink in this adjacent supplementary chamber reaches the maximum, the ink squeezed into this adjacent supplementary chamber and the originally stored ink in this adjacent supplementary chamber will be refilled into the ink storage chamber 101 through the corresponding communicating part.

In addition, the consumable cartridge provided in this embodiment will not have ink overflow during the positive pressure detection process, thus avoiding environmental pollution.

It should be noted that when the consumable cartridge leaves the factory, a certain negative pressure value is maintained inside, that is, the consumable cartridge is in a negative pressure state. The negative pressure value of the consumable cartridge is a specified threshold, and when the consumable cartridge is in a negative pressure state, the force of the internal negative pressure of the consumable cartridge on the valve component 13 and the sealing gasket 12 is greater than the force of the external atmosphere on the sealing gasket 12 and the valve component 13, so the valve component 13 closes the air guide hole 111.

In this embodiment, the main body 10 includes a plurality of supplementary chambers. In the consumable cartridge, both the ink storage chamber 101 and the plurality of supplementary chambers are filled with ink, and the supplementary chambers can be used to supplement ink in the ink storage chamber in real time, thereby increasing the ink capacity of the consumable cartridge and improving the page yield. After the consumable cartridge passes the positive pressure detection of the printer, during the normal printing operation, the inflation unit stops inflating the consumable cartridge. As the gas in the deformable component 30 is discharged through the inflation port 103, the deformable component 30 resumes its deformation. Due to the loss of the expansion force of the deformable component 30, the first deformation member 31 displaces toward the deformable component 30, and the second deformation member 32 rotates toward the deformable component 30 with the valve component 13 as the rotation fulcrum. The consumable cartridge works normally in the printer. During normal printing, the ink supply unit of the printer exerts a suction force on the consumable cartridge, so that the ink stored in the consumable cartridge is supplied to the ink supply unit of the printer. As the ink in the ink storage chamber 101 is consumed, the plurality of supplementary chambers can supplement ink into the ink storage chamber 101 through the communicating parts between them and the ink storage chamber 101.

As the ink in the consumable cartridge is continuously consumed, the negative pressure value inside the consumable cartridge gradually increases. Since the force of the external atmosphere on the sealing gasket 12 and the valve component 13 is greater than the force of the internal negative pressure on the valve component 13 and the sealing gasket 12, both the sealing gasket 12 and the valve component 13 displace away from the air guide hole 111, and external gas enters the ink storage chamber 101 through the air guide hole. When the negative pressure value of the consumable cartridge reaches the specified threshold, the valve component 13 closes the air guide hole 111 again.

In one possible implementation, at least one communicating part is provided between each supplement chamber and the ink storage chamber 101, and at least one communicating part is provided between two adjacent supplement chambers.

In this embodiment, as shown in FIGS. 3 and 4, the main body 10 includes a first supplementary chamber 105a and a second supplementary chamber 105b. The first supplementary chamber 105a is located on one side of the ink storage chamber 101 in the length direction of the consumable cartridge. Specifically, the first supplementary chamber 105a is located on the side of the ink storage chamber 101 in the -X-axis direction. The second supplementary chamber 105b is located on one side of the ink storage chamber 101 in the width direction of the consumable cartridge. Specifically, the second supplementary chamber 105b is located on the side of the ink storage chamber 101 in the +Y-axis direction.

The volume of the first supplementary chamber 105a is larger than that of the second supplementary chamber 105b, that is, the maximum amount of ink that can be filled in the first supplementary chamber 105a is larger than that in the second supplementary chamber 105b.

A first partition 106a is arranged between the first supplementary chamber 105a and the ink storage chamber 101, a second partition 106b is arranged between the second supplementary chamber 105b and the ink storage chamber 101, and a third partition 106c is arranged between the first supplementary chamber 105aand the second supplementary chamber 105b.

As shown in FIG. 5, There are two corresponding communicating parts between the first supplement chamber 105a and the ink storage chamber 101, one corresponding communicating part between the second supplement chamber 105b and the ink storage chamber 101, and one corresponding communicating part between the first supplement chamber 105a and the second supplement chamber 105b. Specifically, a first communicating part 24a and a second communicating part 24b are arranged between the first supplementary chamber 105a and the ink storage chamber 101, the first communicating part 24a communicates the first supplementary chamber 105a and the ink storage chamber 101, and the second communicating part 24b communicates the first supplementary chamber 105a and the ink storage chamber 101; a third communicating part 24c is arranged between the second supplementary chamber 105b and the ink storage chamber 101, the third communicating part 24c communicates the second supplementary chamber 105b and the ink storage chamber 101; a fourth communicating part 24d is arranged between the first supplementary chamber 105a and the second supplementary chamber 105b, the fourth communicating part 24d communicates the first supplementary chamber 105a and the second supplementary chamber 105b.

In a possible implementation, one end of each communicating part away from the partition is closed by the face cover 20, that is, each communicating part is not connected to the side of the face cover 20 away from the partition. This arrangement ensures that the ink in the ink storage chamber 101 and the supplementary chambers cannot flow out of the consumable cartridge through the communicating parts.

Each communicating part is higher than the partition in the height direction of the consumable cartridge, that is, each communicating part is located on the upper side of the corresponding partition in the +Z-axis direction, and there is a fluid path between each communicating part and the partition, so that ink can flow between the ink storage chamber and the supplementary chambers, and between adjacent supplementary chambers through this fluid path.

The communicating part is a structure capable of communicating the ink storage chamber 101 with the supplementary chamber or communicating two adjacent supplementary chambers. In some examples, the communicating part forms a depression on the side facing the partition toward the direction away from the partition, and the depression is located on the side of the face cover 20 facing the partition. In other embodiments, the communicating part can also be a communicating hole.

The shape of the communicating part is not specifically set. In this embodiment, the shape of the first communicating part 24a is square, the shape of the second communicating part 24b is approximately L-shaped, the shape of the third communicating part 24c is square, and the shape of the fourth communicating part 24d is approximately T-shaped.

In the thickness direction of the partition, the communicating part extends from one side of the partition to the other side. Specifically, the thickness direction of the first partition 106a is the X-axis direction, the first communicating part 24a extends from the side of the first partition 106a in the -X-axis direction to the side in the +X-axis direction, and the second communicating part 24b extends from the side of the first partition 106a in the -X-axis direction to the side in the +X-axis direction. In the X-axis direction, the length of the first communicating part 24a is greater than the thickness of the first partition 106a, and the length of the second communicating part 24b is greater than the thickness of the first partition 106a; the thickness direction of the second partition 106b is the Y-axis direction, the third communicating part 24c extends from the side of the second partition 106b in the -Y-axis direction to the side in the +Y-axis direction, and in the Y-axis direction, the length of the third communicating part 24c is greater than the thickness of the second partition 106b; the thickness direction of the third partition 106c is the X-axis direction, the fourth communicating part 24d extends from the side of the third partition 106c in the -X-axis direction to the side in the +X-axis direction, and in the X-axis direction, the length of the fourth communicating part 24d is greater than the thickness of the third partition 106c.

The dashed line with an arrow on the first communicating part 24a in FIG. 6 represents the flow direction of ink from the first supplementary chamber 105a to the ink storage chamber 101, and the solid line with an arrow on the first communicating part 24a represents the flow direction of ink from the ink storage chamber 101 to the first supplementary chamber 105a; the dashed line with an arrow on the second communicating part 24b in FIG. 6 represents the flow direction of ink from the first supplementary chamber 105a to the ink storage chamber 101, and the solid line with an arrow on the second communicating part 24b represents the flow direction of ink from the ink storage chamber 101 to the first supplementary chamber 105a; the dashed line with an arrow on the third communicating part 24c in FIG. 6 represents the flow direction of ink from the second supplementary chamber 105b to the ink storage chamber 101, and the solid line with an arrow on the third communicating part 24c represents the flow direction of ink from the ink storage chamber 101 to the second supplementary chamber 105b; the dashed line with an arrow on the fourth communicating part 24d in FIG. 6 represents the flow direction of ink from the first supplementary chamber 105a to the second supplementary chamber 105b, and the solid line with an arrow on the fourth communicating part 24d represents the flow direction of ink from the second supplementary chamber 105b to the first supplementary chamber 105a.

Exemplarily, when the consumable cartridge is loaded into the printer and the printer performs positive pressure detection while executing a printing command, the inflation unit in the printer inflates the consumable cartridge through the inflation port 103 of the consumable cartridge, the deformable component 30 expands toward the face cover 20, part of the ink stored in the ink storage chamber 101 of the consumable cartridge is squeezed into the ink quantity detection chamber provided in the printer through the ink outlet part, and the other part flows into the second supplementary chamber 105b through the third communicating part 24c. When the amount of ink in the second supplementary chamber 105b reaches the maximum, part of the ink squeezed into the second supplementary chamber 105b and the originally stored ink in the second supplementary chamber 105b is refilled into the ink storage chamber 101 through the third communicating part 24c. Since the first supplementary chamber 105a and the second supplementary chamber 105b are communicated, the other part of the ink is squeezed into the first supplementary chamber 105a through the fourth communicating part 24d. When the amount of ink in the first supplementary chamber 105a reaches the maximum, part of the ink squeezed into the first supplementary chamber 105a and the originally stored ink in the first supplementary chamber 105a is refilled into the ink storage chamber 101 through the first communicating part 24a and the second communicating part 24b; alternatively, when the consumable cartridge is loaded into the printer and the printer performs positive pressure detection while executing a printing command, the inflation unit in the printer inflates the consumable cartridge through the inflation port 103 of the consumable cartridge, the deformable component 30 expands toward the face cover 20, part of the ink stored in the ink storage chamber 101 of the consumable cartridge is squeezed into the ink quantity detection chamber provided in the printer through the ink outlet part, and the other part is squeezed into the first supplementary chamber 105a through the first communicating part 24a and the second communicating part 24b. When the amount of ink in the first supplementary chamber 105a reaches the maximum, part of the ink squeezed into the first supplementary chamber 105a and the originally stored ink in the first supplementary chamber 105a is refilled into the ink storage chamber 101 through the first communicating part 24a and the second communicating part 24b. Since the first supplementary chamber 105a and the second supplementary chamber 105b are communicated, the other part of the ink is squeezed into the second supplementary chamber 105b through the third communicating part 24c. When the amount of ink in the second supplementary chamber 105b reaches the maximum, part of the ink squeezed into the second supplementary chamber 105b and the originally stored ink in the second supplementary chamber 105b is refilled into the ink storage chamber 101 through the third communicating part 24c. This arrangement increases the amount of ink in the ink storage chamber 101, thereby ensuring that a sufficient amount of ink is supplied to the ink detection chamber of the printer through the ink outlet 104a. As a result, the number of times the printer inflates the consumable cartridge during the positive pressure detection process is within the specified threshold range, avoiding situations in the prior art where the ink detection chamber fails to detect the specified amount of ink during positive pressure detection, leading to false prompts that the ink in the consumable cartridge is exhausted, or the printer reports an error because the number of inflations to the consumable cartridge exceeds the threshold. This ensures the normal use of the consumable cartridge, brings convenience to users, avoids waste, and reduces the user's usage cost.

It should also be noted that when the consumable cartridge is installed in the printer and the printer performs positive pressure detection while executing a printing command, the ink stored in the ink storage chamber 101 of the consumable cartridge can also flow into the first supplementary chamber 105a through the first communicating part 24a and the second communicating part 24b, and into the second supplementary chamber 105b through the third communicating part 24c. Since the first supplementary chamber 105a is communicated to the second supplementary chamber 105b and the volume of the first supplementary chamber 105a is larger than that of the second supplementary chamber 105b, when the ink amount in the second supplementary chamber 105b first reaches the maximum value, the ink in the second supplementary chamber 105b will be squeezed into the first supplementary chamber 105a through the fourth communicating part 24d. When the ink amount in the first supplementary chamber 105a reaches the maximum value, the ink in the first supplementary chamber 105a will be filled into the ink storage chamber 101 through the first communicating part 24a and the second communicating part 24b, thereby increasing the ink amount in the ink storage chamber 101.

Finally, it should be noted that the above embodiments are only used to illustrate the technical solutions of the present application, but not to limit them; although the present application has been described in detail with reference to the foregoing embodiments, those of ordinary skill in the art should understand that they can still modify the technical solutions recorded in the foregoing embodiments, or equivalently replace some or all of the technical features; and these modifications or replacements do not make the essence of the corresponding technical solutions deviate from the scope of the technical solutions of the embodiments of the present application.

1. A consumable cartridge, comprising a main body and a face cover;
the main body comprises a partition, an ink storage chamber, and a supplementary chamber, wherein the partition is configured to separate the ink storage chamber from the supplementary chamber;
a plurality of communicating parts are arranged on a side of the face cover facing the partition, the plurality of communicating parts are arranged at intervals, and the plurality of communicating parts are configured to communicate the ink storage chamber with the supplementary chamber, and each communicating part is closed by the face cover on a side away from the partition.

2. The consumable cartridge according to claim 1, wherein the main body comprises a plurality of the supplementary chambers, the plurality of supplementary chambers are arranged around the ink storage chamber, and the partition is also configured to separate two adjacent supplementary chambers;the plurality of communicating parts are configured to communicate the ink storage chamber with the plurality of supplementary chambers, and communicate the adjacent supplementary chambers.

3. The consumable cartridge according to claim 2, wherein at least one communicating part is provided between each of the supplementary chamber and the ink storage chamber, and at least one communicating part is provided between the two adjacent supplementary chambers.

4. The consumable cartridge according to claim 3, wherein each of the communicating part is higher than the partition in the height direction of the consumable cartridge, andthere is a fluid path between the communicating part and the partition.

5. The consumable cartridge according to claim 4, wherein in the thickness direction of the partition, the communicating part extends from one side of the partition to other side of the partition.

6. The consumable cartridge according to claim 5, wherein the communicating part is configured to form a depression on the side facing the partition toward a direction away from the partition.

7. The consumable cartridge according to claim 2, wherein the main body comprises a first supplementary chamber and a second supplementary chamber, the first supplementary chamber is located on one side of the ink storage chamber in the length direction of the consumable cartridge, and the second supplementary chamber is located on one side of the ink storage chamber in the width direction of the consumable cartridge.

8. The consumable cartridge according to claim 7, wherein the communicating part is correspondingly provided between the first supplementary chamber and the ink storage chamber, the communicating part is correspondingly provided between the second supplementary chamber and the ink storage chamber, and the communicating part is correspondingly provided between the first supplementary chamber and the second supplementary chamber.

9. The consumable cartridge according to claim 8, wherein a volume of the first supplementary chamber is larger than that of the second supplementary chamber.

10. The consumable cartridge according to claim 9, the main body is from an original ink cartridge, a recycled ink cartridge, or a remanufactured ink cartridge.
